(19) United States
(12) Patent Application Publication
(10) Pub. No.: US 2026/0178997 A1
(43) Pub. Date: Jun. 25, 2026

(54) LEAST COST PATH SELECTION SYSTEM AND METHOD

(71) Applicant: KOREA ADVANCED INSTITUTE OF SCIENCE AND TECHNOLOGY, Daejeon (KR)

(72) Inventors: In Gwun JANG, Daejeon (KR); Changyeong KIM, Daejeon (KR); Jeonghun KIM, Daejeon (KR); Geunu KIM, Daejeon (KR)

(73) Assignee: KOREA ADVANCED INSTITUTE OF SCIENCE AND TECHNOLOGY, Daejeon (KR)

(21) Appl. No.: 19/080,596

(22) Filed: Mar. 14, 2025

(30) Foreign Application Priority Data
Dec. 21, 2024 (KR) 10-2024-0144119

(51) Int. Cl. G06Q 10/047; G01C 21/34

(52) U.S. Cl. CPC G06Q 10/047; G01C 21/3453

(57) ABSTRACT

A least-cost path selection system includes a computing device. Each of a plurality of travel paths connects any two nodes among a plurality of nodes. The least-cost path is a travel path having the smallest objective function value among the plurality of travel paths. The computing device selects the least-cost path among the plurality of travel paths. A link path is defined as a path connecting any two adjacent nodes among the plurality of nodes. A loop path is defined as a closed path connecting at least three nodes among the plurality of nodes. A loop variable is a variable corresponding to the loop path and having a value and a direction. A link variable is a variable whose direction is determined by loop variables adjacent to the link path. A link cost is a constant corresponding to the link path. The computing device modifies at least one of the plurality of loop variables based on at least one of Loop-wise Route Representation (LRR) and a circuit analysis method to calculate a plurality of reference link variables, each being a link variable with a determined direction. The circuit analysis method includes at least one of Mesh Current Method (MCM), Nodal Analysis, and Numerical Method. The computing device modifies the values of the plurality of loop variables within the range where the directions of the plurality of reference link variables remain unchanged. The computing device selects the least-cost path using a linear objective function.

### CROSS-REFERENCE TO RELATED APPLICATIONS

This application claims priority to and benefits of Korean Patent Application No. 10-2024-0144119 under 35 U.S.C § 119, filed on Oct. 21, 2024, in the Korean Intellectual Property Office, the contents of which are incorporated herein in its entirety by reference.

### BACKGROUND

### 1. Technical Field

The present disclosure relates to a system and method for selecting a least-cost path based on loop variables. More specifically, it pertains to a least-cost path selection system and method that minimizes computational load by utilizing a linear objective function.

### 2. Description of the Related Art

The route optimization problem, which involves finding an optimal travel path from one of a plurality of nodes to another, has been studied across various fields, including traffic engineering, mechanical engineering, and industrial engineering. Beyond simply determining the shortest path, there is a growing need to develop technologies that consider multiple factors, such as time, distance, and energy consumption, to select the optimal travel path, hereinafter referred to as the least-cost path.

Accordingly, a loop-wise route representation (LRR) method, which uses loop variables to express paths, has been proposed. This method allows the selection of an optimal travel path with fewer variables compared to using link variables, and it has the advantage of not requiring additional constraints to ensure path connectivity.

However, the conventional LRR methods rely on nonlinear objective functions, which result in high computational loads. To address these challenges, inefficient approximation algorithms are often required, which presents a significant drawback.

### SUMMARY

An object of the present disclosure is to provide a system and method for selecting a least-cost path by defining a linear objective function using at least one of Loop-wise Route Representation (LRR) and a circuit analysis method, and applying the objective function to select the least-cost path.

A least-cost path selection system according to an embodiment of the present disclosure may include a computing device. The computing device may be configured to select a least-cost path among a plurality of travel paths. Each of the plurality of travel paths may connect any two nodes among a plurality of nodes. The least-cost path may be a travel path with the smallest objective function value among the plurality of travel paths. A link path may be defined as a path connecting any two adjacent nodes among the plurality of nodes. A loop path may be defined as a closed path connecting at least any three nodes among the plurality of nodes. A loop variable may be a variable corresponding to a loop path and having a value and a direction. A link variable may be a variable whose direction is determined by loop variables adjacent to the link path. A link cost may be a constant corresponding to the link path. The computing device may be configured to modify at least one of a plurality of loop variables based on at least one of Loop-wise Route Representation (LRR) and a circuit analysis method to calculate a plurality of reference link variables. The circuit analysis method may include at least one of Mesh Current Method (MCM), Nodal Analysis, and Numerical Method. Each of the reference link variables may be a variable whose direction is determined. The computing device may be configured to modify the value of each of the plurality of loop variables, as long as the direction of each of the plurality of reference link variables remains unchanged, and use an objective function to select the least-cost path. The objective function may be a linear function.

In the LRR according to an embodiment of the present disclosure, the computing device may be configured to perform iterations a predetermined number of times. Each iteration may involve modifying at least a subset of the plurality of loop variables. In one embodiment, the predetermined number of iterations may be equal to or greater than 1 and equal to or less than 10.

In an embodiment of the present disclosure, the MCM may include defining a plurality of meshes in an electrical circuit having a plurality of resistors and then using the plurality of resistors to calculate a plurality of mesh currents corresponding to the plurality of meshes. In the MCM, a plurality of link costs may be used instead of the plurality of resistors to calculate the plurality of mesh currents. The computing device may be configured to calculate the plurality of mesh currents as a plurality of loop variables, respectively.

In an embodiment of the present disclosure, the computing device may be configured to use the objective function to calculate a plurality of objective function values associated with the plurality of travel paths. The least-cost path may be a travel path with the smallest objective function value among the plurality of objective function values.

In an embodiment of the present disclosure, when the least-cost path serves as the travel path to solve a shortest path problem, the computing device may be configured to select the least-cost path based on Equation 1 and Equation 2. Equation 1 may be

$$Minimize f ( \overline{X} ) = {\sum }_{( i , j ) ∈ P} {c}_{i , j} {x}_{i , j} ( {\overline{x}}^{( k )} ) .$$

### Equation 2 may be

$$g ( \overline{X} ) = - {x}_{i , j} ( {\overline{x}}^{( k )} ) \leq 0 ∀ ( i , j ) ∈ P$$

$$- 1 \leq {\overline{x}}^{( k )} \leq 1 ∀ k .$$

f(X̅) may represent the objective function. i,j may correspond to node i and node j, respectively, among the plurality of nodes. P may correspond to the set of reference link variables. c_{i,j} may be the link cost corresponding to the link path connecting node i and node j among the plurality of link costs. x_{i,j} may be the link variable corresponding to the link path connecting node i and node j among the plurality of link variables. x̅^{(k)} may be loop variables adjacent to x_{i,j} among the plurality of link variables.

In an embodiment of the present disclosure, when the least-cost path serves as the travel path to solve a Traveling Salesman Problem (TSP), the computing device may be configured to select the least-cost path based on Equation 1 and Equation 3. Equation 1 may be

$$Minimize f ( \overline{X} ) = {\sum }_{( i , j ) ∈ P} {c}_{i , j} {x}_{i , j} ( {\overline{x}}^{( k )} ) ,$$

### and Equation 3 may be

$$g ( \overline{X} ) = - {x}_{i , j} ( {\overline{x}}^{( k )} ) \leq 0 ∀ ( i , j ) ∈ P$$

$${g}_{w} ( \overline{X} ) = b - \sum {x}_{w , adj} ( {\overline{x}}^{( k )} ) \leq 0 ∀ w$$

$$- 2 \leq {x}^{( k )} \leq 2 ∀ k .$$

f(X̅) may represent the objective function. i,j may correspond to node i and node j, respectively, among the plurality of nodes. P may correspond to the set of reference link variables. c_{i,j} may be the link cost corresponding to the link path connecting node i and node j among the plurality of link costs x_{i,j} may be the link variable corresponding to the link path connecting node i and node j among the plurality of link variables. x̅^{(k)} may be loop variables adjacent to x_{i,j} among the plurality of link variables. b may be the value of a base path variable. w may be a node among the plurality of nodes that corresponds to an intermediate point. x_{w,adj} may be link variables adjacent to the node corresponding to the intermediate point among the plurality of link variables.

In an embodiment of the present disclosure, the computing device may be configured to select the least-cost path using at least one of: constrained optimization algorithm, convex optimization, gradient-based methods, meta-heuristic algorithm, nature-inspired algorithm, interior-point methods, dynamic programming, linear programming, and deep learning.

In an embodiment of the present disclosure, the constrained optimization algorithm may be a sensitivity-based exact method. The sensitivity-based exact method may include at least one of: simplex algorithm, interior-point method, branch and bound, and Lagrange multiplier method.

In an embodiment of the present disclosure, the link cost may be at least one of travel distance, travel time, and energy consumption that correspond to the link path.

The least-cost path selection system according to an embodiment of the present disclosure may further include a user terminal. The user terminal may be configured to communicate with the computing device, which, in turn, may provide the least-cost path to the user terminal.

In an embodiment of the present disclosure, the user terminal may be coupled to a vehicle. In an embodiment of the present disclosure, the computing device may be configured for at least one of urban environment management and mobility control.

A least-cost path selection method according to an embodiment of the present disclosure may include defining a base variable, calculating a reference link variable, and selecting a least-cost path. In the step of defining a base variable, the computing device may define link costs, link variables, and loop variables between a plurality of nodes. The loop variable may be a variable corresponding to a loop path and having a value and a direction. The loop path may be a closed path connecting at least three nodes among the plurality of nodes. The link variable may be a variable whose direction is determined by loop variables adjacent to a link path. The link path may be a path connecting any two adjacent nodes among the plurality of nodes. The link cost may be a constant corresponding to the link path.

In the step of calculating a reference link variable, the computing device may modify at least one of the plurality of loop variables based on at least one of Loop-wise Route Representation (LRR) and a circuit analysis method to calculate a plurality of reference link variables. The circuit analysis method may include at least one of Mesh Current Method (MCM), Nodal Analysis, and Numerical Method. Each of the plurality of reference link variables may be a link variable whose direction is determined.

In the step of selecting a least-cost path, the computing device may modify the value of each of the plurality of loop variables within a range in which the direction of each of the plurality of reference link variables remain unchanged. The computing device may use a linear objective function to select the least-cost path. The least-cost path may be a travel path with the smallest objective function value among a plurality of travel paths, each connecting any two nodes of the plurality of nodes.

In the LRR of the step of calculating a reference link variable according to an embodiment of the present disclosure, the computing device may perform iterations a predetermined number of times. Each iteration may involve modifying at least a subset of the plurality of loop variables.

In an embodiment of the present disclosure, the MCM may include defining a plurality of meshes in an electrical circuit having a plurality of resistors and then using the plurality of resistors to calculate a plurality of mesh currents corresponding to the plurality of meshes. In the MCM of the step of calculating a reference link variable, a plurality of link costs may be used instead of the plurality of resistors to calculate the plurality of mesh currents. The computing device may calculate the plurality of mesh currents as a plurality of loop variables, respectively.

In the step of selecting a least-cost path according to an embodiment of the present disclosure, the computing device may generate a plurality of travel paths based on the plurality of reference link variables and the plurality of link costs. The computing device may use the objective function to calculate a plurality of objective function values associated with the plurality of travel paths.

In the step of selecting a least-cost path according to an embodiment of the present disclosure, the computing device may select the least-cost path based on at least one of Equation 1, Equation 2, and Equation 3. Equation 1 may be

$$Minimize f ( \overline{X} ) = {\sum }_{( i , j ) ∈ P} {c}_{i , j} {x}_{i , j} ( {\overline{x}}^{( k )} ) .$$

### Equation 2 may be

$$g ( \overline{X} ) = - {x}_{i , j} ( {\overline{x}}^{( k )} ) \leq 0 \qquad ∀ ( i , j ) ∈ P$$

$$\begin{matrix}- 1 \leq {\overline{x}}^{( k )} \leq 1 & ∀ k\end{matrix} .$$

### Equation 3 may be

$$g ( \overline{X} ) = - {x}_{i , j} ( {\overline{x}}^{( k )} ) \leq 0 \qquad ∀ ( i , j ) ∈ P$$

$${g}_{w} ( \overline{X} ) = b - \sum {x}_{w , adj} ( {\overline{x}}^{( k )} ) \leq 0 \qquad ∀ w$$

$$- 2 \leq {\overline{x}}^{( k )} \leq 2 \qquad ∀ k .$$

f(x̅) may represent the objective function. i,j may correspond to node i and node j, respectively, among the plurality of nodes. P may correspond to the set of reference link variables. c_{i,j} may be the link cost corresponding to the link path connecting node i and node j among the plurality of link costs. x_{i,j} is may be the link variable corresponding to the link path connecting node i and node j among the plurality of link variables. x̅^{(k)} may be loop variables adjacent to x_{i,j} among the plurality of link variables. 6 may be the value of a base path variable. w may be a node among the plurality of nodes that corresponds to an intermediate point. x_{w,adj} may be link variables adjacent to the node corresponding to the intermediate point among the plurality of link variables.

In the step of selecting a least-cost path according to an embodiment of the present disclosure, the computing device may select the least-cost path using at least one of constrained optimization algorithm, convex optimization, gradient-based methods, meta-heuristic algorithm, nature-inspired algorithm, interior-point methods, dynamic programming, linear programming, and deep learning, the constrained optimization algorithm may be a sensitivity-based exact method.

According to an embodiment of the present disclosure, it is possible to provide a system and method for selecting a least-cost path by defining a linear objective function using at least one of Loop-wise Route Representation (LRR) and a circuit analysis method and applying the objective function.

### BRIEF DESCRIPTION OF THE DRAWINGS

These and/or other features will become apparent and more readily appreciated from the following description of the embodiments, taken in conjunction with the accompanying drawings in which:

FIG. 1 illustratively shows a least-cost path selection system according to an embodiment of the present disclosure;

FIGS. 2A to 2C are exemplary diagrams for illustrating the link cost, link variable, loop variable, and reference link variable defined in a node network;

FIGS. 3A to 3F are exemplary diagrams for illustrating the process of calculating the reference link variable of FIG. 2C based on Loop-wise Route Representation (LRR);

FIGS. 4A and 4B are exemplary diagrams for illustrating the process of calculating the reference link variable of FIG. 2C based on Mesh Current Method (MCM); and

FIG. 5 is an exemplary flowchart illustrating a least-cost path selection method according to an embodiment of the present disclosure.

### DETAILED DESCRIPTION

References will now be made in detail to certain embodiments, of which examples are illustrated in the accompanying drawings, where like reference numerals refer to like elements throughout. The embodiments may have a variety of forms and permutations, but the present disclosure shall by no means be construed as being limited to the described embodiments. Rather, the present disclosure shall be construed to encompass all forms, permutations, equivalents and substitutes covered by the technical ideas and scope of the present disclosure. Accordingly, the embodiments are merely described below, by referring to the figures, to explain features of the present disclosure.

Hereinafter, certain preferred embodiments of the present disclosure will be described in greater detail with reference to the accompanying drawings, in which the proportions and dimensions of elements may be exaggerated for effective description and illustration of the associated technical features.

The term “include,” “comprise,” or similar terminology is intended to specify the presence of features, numbers, steps, operations, elements, parts, or combinations thereof described in the specification, and should not be construed as precluding the possibility of the presence or addition of one or more other features, numbers, steps, operations, elements, parts, or combinations thereof.

Additionally, when an element is described as being “on” another element, it means that the element may be positioned above or below the referenced element and does not necessarily imply an upward position based on gravitational direction.

Furthermore, when an element is described as being “connected” or “coupled” to another element, it should be understood to encompass cases where the element is directly connected or coupled to the other element as well as cases where the element is indirectly connected or coupled through another element.

In addition, terms such as first and second may be used to describe certain elements, but such terms are merely for distinguishing one element from another and are not intended to limit the essence, sequence, or order of the corresponding elements.

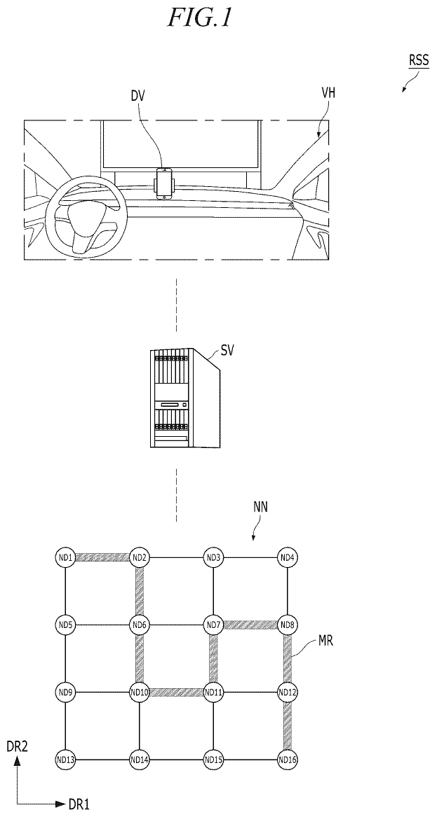

FIG. 1 illustratively shows a least-cost path selection system RSS according to an embodiment of the present disclosure. Referring to FIG. 1, the least-cost path selection system RSS may include a computing device SV and a user terminal DV. A node network NN may be a network of multiple interconnected nodes ND1-ND16.

The computing device SV may be configured to select a least-cost path MR among a plurality of travel paths within the node network NN. Each of the plurality of travel paths may be a travel path connecting any two nodes, such as ND1 and ND16, among the plurality of nodes ND1-ND16. The least-cost path MR may be the final travel path provided to a user. In an embodiment of the present disclosure, the computing device SV may be configured for at least one of urban environment management and mobility control.

The user terminal DV may be configured to communicate with the computing device SV and to receive the least-cost path MR as the final travel path from the computing device SV. That is, the user may refer to the provided least-cost path MR via the user terminal DV for navigation. In an embodiment of the present disclosure, the user terminal DV may be integrated into a vehicle VH. Alternatively, the user terminal DV may be omitted.

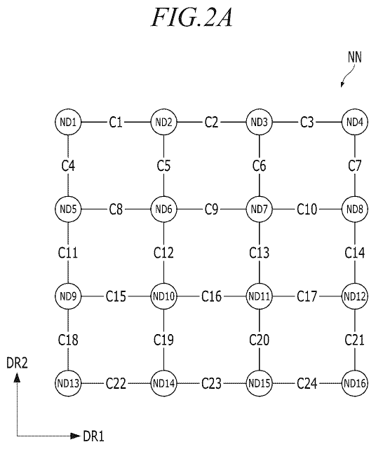

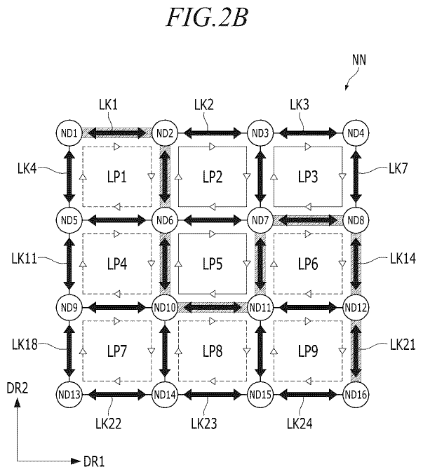

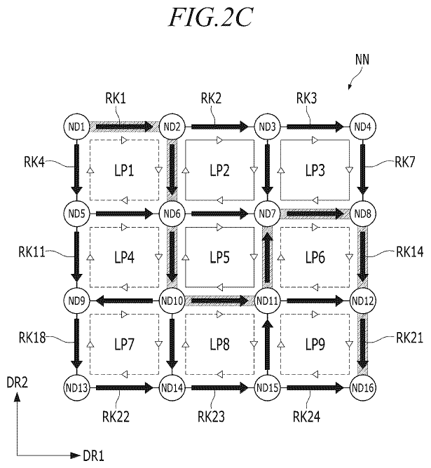

The least-cost path MR may be a travel path having the smallest objective function value among the plurality of travel paths. The objective function value may be at least one of travel distance, travel time, and energy consumption required to traverse the travel path. The objective function value may be calculated based on link variables and link costs illustrated in FIG. 2A.

FIG. 2A illustratively shows a plurality of link costs C1-C24 defined in the node network NN of FIG. 1. FIG. 2B illustratively shows a plurality of link variables LK1-LK24 and a plurality of loop variables LP1-LP9 defined in the node network NN of FIG. 1. FIG. 2C illustratively shows a plurality of reference link variables RK1-RK24 defined in the node network NN of FIG. 1.

Referring to FIGS. 2A and 2B, a link path may be a path connecting any two adjacent nodes among the plurality of nodes ND1-ND16. A loop path may be a closed path connecting at least three nodes among the plurality of nodes ND1-ND16.

Referring to FIG. 2A, a link cost C may be a constant representing the travel cost corresponding to a link path. In an embodiment of the present disclosure, the link cost C may be at least one of travel distance, travel time, and energy consumption corresponding to the link path. For example, a first link cost C1 may represent the energy consumption for the link path connecting a first node ND1 and a second node ND2. The link cost C may be a predetermined constant for the link path and may be used to calculate the objective function value.

Referring to FIG. 2B, a loop variable LP may represent the travel amount and travel direction corresponding to a loop path and may be a variable having a value and a direction. A plurality of loop variables LP1-LP9 may be defined among the plurality of nodes ND1-ND16. A first loop variable LP1 may correspond to the loop path sequentially connecting the first node ND1, the second node ND2, a sixth node ND6, and a fifth node ND5. A second loop variable LP2 may correspond to the loop path sequentially connecting the second node ND2, a third node ND3, a seventh node ND7, and the node ND6. In an embodiment of the present disclosure, the direction of the loop variable LP may be either clockwise or counterclockwise, and the value of the loop variable LP may be greater than or equal to 0 and less than or equal to 1.

A link variable LK may represent the travel amount and travel direction corresponding to a link path and may be a variable whose direction is determined by adjacent loop variables. For example, the direction of the link variable LK may be one of a first direction DR1, the reverse of the first direction DR1, a second direction DR2, and the reverse of the second direction DR2. The first direction DR1 may intersect with the second direction DR2.

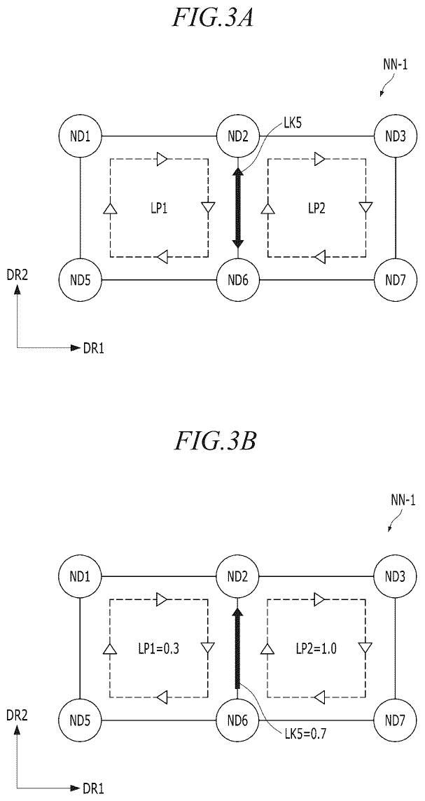

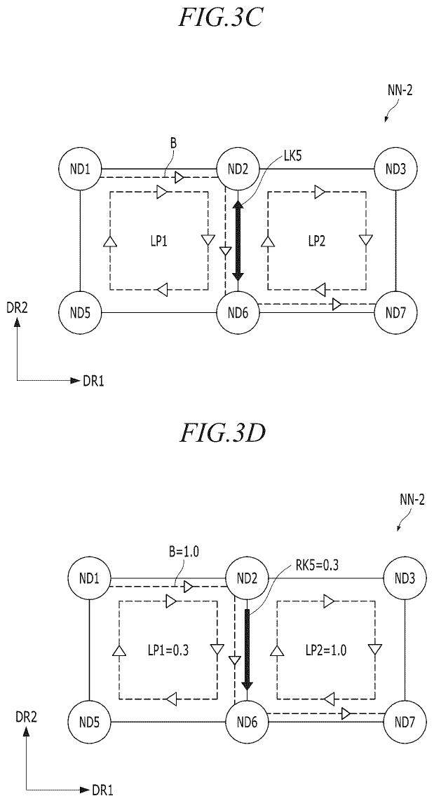

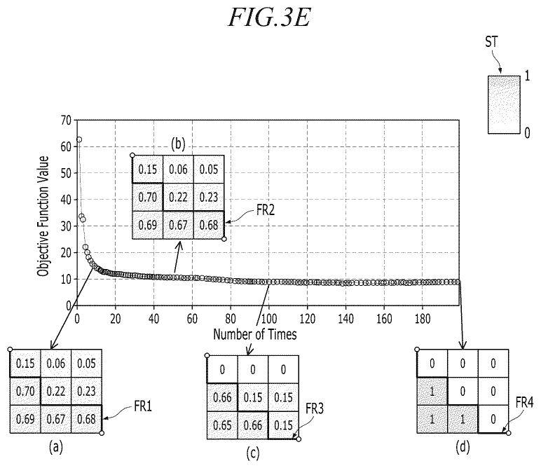

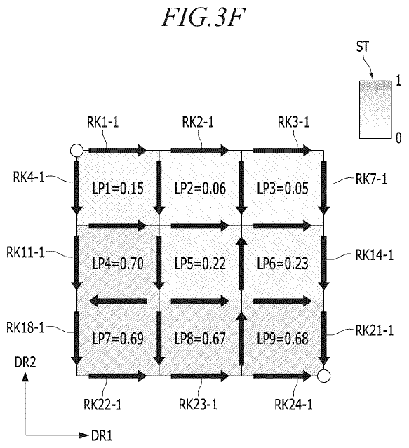

Referring to FIG. 2B, a sixth link variable LK6 may correspond to the link path connecting the second node ND2 and the sixth node ND6. The direction of the sixth link variable LK6 may be determined as either the first direction DR1 or the reverse of the first direction DR1 by the first loop variable LP1 and the second loop variable LP2. The process of determining the direction of the sixth link variable LK6 will be described in detail with reference to FIGS. 3A to 3D.

Referring to FIG. 2C, in an embodiment of the present disclosure, the computing device SV may be configured to calculate a plurality of reference link variables RK1-RK24 by modifying at least a portion of the plurality of loop variables LP1-LP9 based on at least one of Loop-wise Route Representation (LRR) and a circuit analysis method. The circuit analysis method may include at least one of Mesh Current Method (MCM), Nodal Analysis, and Numerical Method. In the present specification, MCM refers to a method of analyzing a circuit by setting the current of a closed circuit as a variable, Nodal Analysis refers to a method of analyzing a circuit by setting the voltage of a node as a variable, and Numerical Method refers to a method of analyzing a circuit by utilizing matrix operations or iterative approximation calculations. Each of the plurality of reference link variables RK1-RK24 may be a link variable LK having a determined direction. For example, of the first direction DR1 and the reverse of the first direction DR1, the direction of the first reference link variable RK1 may be the first direction DR1. The direction of the fifth reference link variable RK5 may be the reverse of the second direction DR2.

In an embodiment of the present disclosure, the computing device SV may be configured to use an objective function to calculate a plurality of objective function values associated with a plurality of travel paths. The objective function may be a function for calculating an objective function value of a travel path. The least-cost path MR may be a travel path having the smallest objective function value among the plurality of objective function values. The plurality of reference link variables RK1-RK24 may be variables calculated for the purpose of linearizing the objective function.

In an embodiment of the present disclosure, the computing device SV may be configured to modify the values of the plurality of loop variables LP1-LP9 within a range where the directions of the plurality of reference link variables RK1-RK24 remain unchanged and select the least-cost path MR using the linear objective function. The computing device SV may be configured to modify the values of the plurality of loop variables LP1-LP9 to select the least-cost path MR having a smaller objective function value. However, in the present disclosure, the range within which the values of the plurality of loop variables LP1-LP9 are modified to select the least-cost path MR may be limited to the range where the directions of the plurality of reference link variables RK1-RK24 remain unchanged (hereinafter referred to as constraint condition). The constraint condition may be a condition for linearizing the objective function and efficiently selecting the least-cost path MR. The necessity of the constraint condition is described below.

The objective function value may be the sum of a plurality of objective function value components (ΣΣ_{cij}xᵢⱼ(x̅^{(k)}). In conventional techniques, the directions of link variables LK may change through iterations. Consequently, a negative value may be calculated for an objective function value component c_{i,j}x_{i,j}(x̅^{(k)}) corresponding to a link path, resulting in an objective function value of a travel path being calculated smaller than its actual value. In conventional techniques, to prevent such a problem, a nonlinear objective function

$$( f ( \overline{X} ) = {\sum }_{i = 1} {\sum }_{j = 1} {c}_{ij} \vert {x}_{ij} ( {\overline{x}}^{( k )} ) \vert )$$

was used to correct the negative objective function value component to a positive value.

However, when a nonlinear function is used as the objective function, more computation is required to select the least-cost path MR compared to when a linear function is used as the objective function. That is, in conventional techniques, the nonlinear objective function required extensive computation to select the least-cost path MR.

On the other hand, in the present disclosure, since the values of the plurality of loop variables LP1-LP9 are modified only within the range that satisfies the above-described constraint condition, the problem of yielding a negative value from the calculation of the objective function value component c_{i,j}x_{i,j}(x̅^{(k)}), as in conventional techniques, can be prevented in advance. Furthermore, since the objective function

$$( f ( \overline{X} ) = {\sum }_{( i , j ) ∈ P} {c}_{i , j} {x}_{i , j} ( {\overline{x}}^{( k )} ) )$$

of the present disclosure is a linear function, the least-cost path MR can be selected with less computation compared to conventional techniques.

In summary, it is possible for the computing device SV of the present disclosure to select the least-cost path MR with less computation by linearizing the objective function using the above-described plurality of reference link variables RK1-RK24.

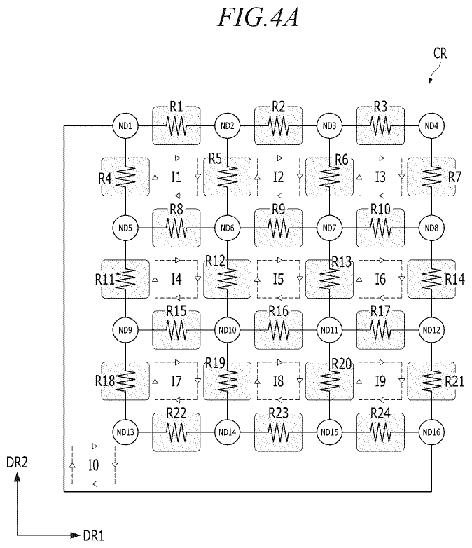

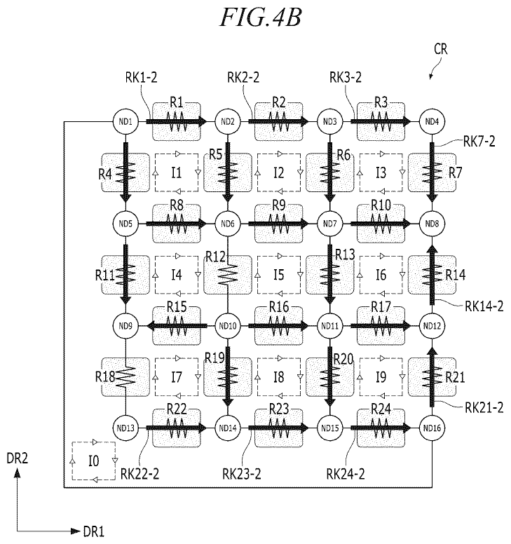

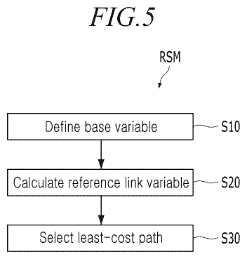

The plurality of reference link variables RK1-RK24 may be calculated based on either Loop-wise Route Representation (LRR) or a circuit analysis method. The circuit analysis method may include at least one of Mesh Current Method (MCM), Nodal Analysis, and Numerical Method. The process of calculating the plurality of reference link variables RK1-RK24 based on LRR will be described with reference to FIGS. 3A to 3F, and the process of calculating the plurality of reference link variables RK1-RK24 based on MCM will be described with reference to FIGS. 4A and 4B.

FIGS. 3A and 3B illustratively show a node network NN-1 before and after the values and directions of link variables are determined. Referring to FIGS. 3A and 3B, in an embodiment of the present disclosure, the values and directions of link variables may be determined by adjacent loop variables. The value of a link variable corresponding to a link path may be determined by subtracting the smaller value from the larger value among the values of two adjacent loop variables. The direction of the link variable corresponding to the link path may be determined to be the same as the direction of the loop variable having the larger value among the two adjacent loop variables.

For example, a fifth link variable LK5 may be a link variable corresponding to the link path connecting the second node ND2 and the sixth node ND6. The first loop variable LP1 and the second loop variable LP2 may be loop variables adjacent to the link path connecting the second node ND2 and the fifth node ND5. If the value of the first loop variable LP1 is 0.3 and the value of the second loop variable LP2 is 1.0, the value of the fifth link variable LK5 may be determined to be 0.7, and the direction thereof may be determined to be the second direction DR2.

FIGS. 3C and 3D illustratively show a node network NN-2 before and after the values and directions of link variables are determined.

Referring to FIGS. 3C and 3D, in an embodiment of the present disclosure, the values and directions of link variables LK may be determined by a base path variable B and adjacent loop variables. The computing device SV may be configured to determine the value and direction of a link variable corresponding to a link path based on the base path variable B corresponding to the link path and the adjacent loop variables.

A base path may be a travel path that is predetermined to connect any two nodes among the plurality of nodes ND1-ND16 and may be used as a criterion for selecting a target travel path FR (shown in FIG. 3E). The least-cost path MR may be the final travel path provided to the user, whereas the target travel path FR may be a travel path generated during the selection of the least-cost path.

Referring to FIGS. 3C and 3D, the base path may be a travel path starting from the first node ND1, passing sequentially through the second node ND2 and the sixth node ND6, and arriving at the seventh node ND7. However, this is merely an example, and the base path of the present disclosure is not limited to the one shown in FIG. 3E.

The base path variable B may correspond to the base path and may be a variable having a value and a direction. The value of the base path variable B may be a predetermined positive number. The direction of the base path variable B may be the same as the direction of the base path.

The computing device SV may be configured to determine the value and direction of a link variable LK by adding or subtracting the values of adjacent loop variables to the value of the base path variable B. The computing device SV may be configured to add, among the loop variables adjacent to the link path, the value of a loop variable LP having the same direction as the base path variable B to the value of the base path variable B and subtract the value of a loop variable LP having a direction different from the base path variable B from the value of the base path variable B to determine the value of the link variable LK corresponding to the link path. If the value of the link variable LK is positive, the direction of the link variable LK may be determined to be the same as the direction of the base path variable B, and if the value of the link variable LK is negative, the direction of the link variable LK may be determined to be the reverse of the direction of the base path variable B.

Referring to FIGS. 3C and 3D, the fifth link variable LK5 may be a link variable corresponding to the link path connecting the second node ND2 and the sixth node ND6. The first loop variable LP1 and the second loop variable LP2 may be loop variables adjacent to the link path connecting the second node ND2 and the sixth node ND6. The direction of the first loop variable LP1 may be the same as the direction of the base path variable B, while the direction of the second loop variable LP2 may be different from the direction of the base path variable B. For example, if the value of the base path variable B is 1.0, the value of the first loop variable LP1 is 0.3, and the value of the second loop variable LP2 is 1.0, the value of the sixth link variable LK6 may be determined to be 0.3, and the direction thereof may be determined to be the reverse of the second direction DR2.

FIGS. 3E and 3F illustratively show the process in which the computing device SV modifies at least a portion of the plurality of loop variables LP1-LP9 through a first iteration and calculates a plurality of reference link variables RK1-1-RK24-1 based on the modified loop variables LP1-LP9.

Iteration may be an operation that modifies at least a portion of the plurality of loop variables LP1-LP9 to generate a travel path having a smaller objective function value. In an embodiment of the present disclosure, the iteration may be either the first iteration or the second iteration.

Referring to FIG. 3E, the x-axis of the graph represents the number of times the first iteration is performed, and the y-axis represents the objective function value of the target travel path FR. In FIG. 3E, (a) to (d) visually represent the plurality of loop variables LP1-LP9 modified through the first iteration. The shading ST of the area corresponding to the loop variable may vary depending on the value of the loop variable. For example, the closer the value of the loop variable is to 1, the darker the corresponding area may appear, and the closer the value is to 0, the lighter the area may appear. However, this is merely an example, and the present disclosure is not limited to FIG. 3E.

The first iteration and the second iteration may be performed for different purposes. Specifically, the first iteration is an operation in which the computing device SV modifies at least a portion of the plurality of loop variables LP1-LP9 to calculate the plurality of reference link variables RK1-1-RK24-1. On the other hand, the second iteration may be an operation in which the computing device SV modifies at least a portion of the plurality of loop variables LP1-LP9 within the range satisfying the above-described constraint condition to select the least-cost path.

With each execution of the first iteration, a travel path with a smaller objective function value may be generated. That is, the computing device SV may be configured to perform the first iteration to select a target travel path FR having a smaller objective function value than the base path. The target travel path FR may be the travel path having the smallest objective function value among the plurality of travel paths generated based on the modified loop variables.

When the computing device SV performs the first iteration, at least one of the plurality of loop variables LP1-LP9 may be modified, and the direction of each link variable among the plurality of link variables may be determined by the plurality of modified loop variables LP1-LP9 in the same manner as described with reference to FIGS. 3A to 3D.

In an embodiment of the present disclosure, the computing device SV may be configured to perform the first iteration a predetermined number of times and then calculate the link variables with determined directions as reference link variables RK. For example, the predetermined number of times may be greater than or equal to 1 and less than or equal to 10.

Referring to FIG. 3F, the computing device SV may be configured to determine the direction of each of the plurality of link variables LK1-LK24 based on the modified plurality of loop variables LP1-LP9 and calculate the plurality of reference link variables RK1-1-RK24-1.

In an embodiment of the present disclosure, the computing device SV may be configured to perform the first iteration using at least one of convex optimization, gradient-based methods, meta-heuristic algorithm, nature-inspired algorithm, interior-point methods, dynamic programming, linear programming, and deep learning.

When the first iteration is sufficiently performed, the plurality of loop variables LP1-LP9 may be clustered into a region where the value of the loop variable is 0 and a region where the value is not 0. The target travel path FR may be the travel path corresponding to the boundary between the region where the loop variable value is 0 and the region where the loop variable value is not 0.

In FIG. 3E, (a) illustratively shows a first target travel path FR1 selected when the first iteration is performed five times. In FIG. 3E, (b) illustratively shows a second target travel path FR2 selected when the first iteration is performed fifty times. In FIG. 3E, (c) illustratively shows a third target travel path FR3 selected when the first iteration is performed one hundred times. In FIG. 3E, (d) illustratively shows a fourth target travel path FR4 selected when the first iteration is performed one hundred ninety-nine times.

Referring to (a) to (d) in FIG. 3E, the more the first iteration is performed, the smaller the objective function value of the selected target travel path FR may become. However, the more the first iteration is performed, the longer it takes to select the target travel path FR. In conventional techniques, selecting the target travel path FR through a large number of first iterations and providing the selected target travel path FR to the user as the final travel path required extensive computation and a long time.

On the other hand, the computing device SV of the present disclosure may be configured to calculate the plurality of reference link variables RK1-1-RK24-1 by performing the first iteration fewer times than in conventional techniques. Subsequently, the computing device SV may select the final travel path, which is the least-cost path MR, using the linear objective function, thereby providing the final travel path with less computation and in a shorter time.

FIGS. 4A and 4B illustratively show the process of calculating the reference link variables RK of FIG. 2C based on the Mesh Current Method (MCM). FIG. 4A illustratively shows an electrical circuit CR corresponding to the node network NN1 of FIG. 2A.

MCM is one of the methods for analyzing an electrical circuit CR that includes a plurality of resistors R1-R24. MCM may include defining a plurality of meshes and a plurality of mesh currents I0-I9 in the electrical circuit CR, generating a plurality of equations corresponding, respectively, to the plurality of meshes based on Kirchhoff's Voltage Law, and calculating the plurality of mesh currents I0-I9 based on the plurality of equations. Each of the plurality of equations may be an equation for mesh currents and resistances, and the first mesh current I1 to the ninth mesh current I9 may correspond, respectively, to the plurality of meshes.

Since the loop paths and loop variables of the node network NN have similar characteristics to the meshes and mesh currents of the electrical circuit CR, MCM may be utilized to analyze the node network NN. In an embodiment of the present disclosure, the computing device SV may be configured to calculate a plurality of reference link variables RK1-2-RK24-2 based on MCM.

Referring to FIG. 4A, the electrical circuit CR may include a plurality of resistors R1-R24, each of which may be disposed between any two adjacent nodes among the plurality of nodes ND1-ND16. A plurality of meshes and a plurality of mesh currents I0-I9 may be defined in the electrical circuit CR. The base mesh current I0 may be a mesh current having a predetermined value. Among the plurality of mesh currents I0-I9, the first to ninth mesh currents I1-I9 may correspond, respectively, to the plurality of meshes.

The computing device SV may be configured to generate a plurality of equations for the first to ninth mesh currents I1-I9 and the plurality of resistors R1-R24 based on Kirchhoff's Voltage Law. The computing device SV may also be configured to generate a mesh current matrix to calculate the mesh currents based on the plurality of equations.

$$[ Mesh Current Matrix ]$$

$$[ \begin{matrix}\text{?} & \text{?} & 0 & \text{?} & 0 & 0 & 0 & 0 & 0 \\ \text{?} & \text{?} & \text{?} & 0 & \text{?} & 0 & 0 & 0 & 0 \\ 0 & \text{?} & \text{?} & 0 & 0 & \text{?} & 0 & 0 & 0 \\ \text{?} & 0 & 0 & \text{?} & \text{?} & 0 & \text{?} & 0 & 0 \\ 0 & \text{?} & 0 & \text{?} & \text{?} & \text{?} & 0 & \text{?} & 0 \\ 0 & 0 & \text{?} & 0 & \text{?} & \text{?} & 0 & 0 & \text{?} \\ 0 & 0 & 0 & \text{?} & 0 & 0 & \text{?} & \text{?} & 0 \\ & 0 & 0 & 0 & 0 & 0 & \text{?} & \text{?} & \text{?} \\ & & 0 & 0 & 0 & 0 & 0 & \text{?} & \text{?}\end{matrix} ] [ \begin{matrix}{I}_{1} \\ {I}_{2} \\ {I}_{3} \\ {I}_{4} \\ {I}_{5} \\ {I}_{6} \\ {I}_{7} \\ {I}_{8} \\ {I}_{9}\end{matrix} ] \text{?} [ \begin{matrix}\text{?} \\ 0 \\ 0 \\ \text{?} \\ 0 \\ 0 \\ \text{?} \\ \text{?} \\ \text{?}\end{matrix} ]$$

$$\text{?} \text{indicates text missing or illegible when filed}$$

In MCM, the computing device SV may be configured to calculate the mesh currents I1-I9 by substituting the plurality of link costs C1-C24 for the plurality of resistors R1-R24 in the mesh current matrix. For example, the computing device SV may substitute the first resistor R1, the third resistor R3, and the twenty-fourth resistor R24 in the mesh current matrix with the first link cost C1, the third link cost C3, and the twenty-fourth link cost C24, respectively.

Referring to FIG. 4B, the computing device SV may calculate the first to ninth mesh currents I1-I9 as the plurality of loop variables LP1-LP9 and calculate the plurality of reference link variables RK1-2-RK24-2 based on the plurality of loop variables LP1-LP9.

Hereinafter, the equations for defining the objective function and the constraint condition of the present disclosure are described in detail. The least-cost path MR may be a travel path for solving either the shortest path problem or the traveling salesman problem.

The constraint condition may be a condition that restricts the range in which the values of the plurality of loop variables LP1 to LP9 can be modified to ensure that the directions of the plurality of reference link variables RK1-RK24 remain unchanged. The constraint condition may be defined as one of a first constraint condition and a second constraint condition, depending on the purpose of selecting the least-cost path MR. The first constraint condition corresponds to the case where the least-cost path MR is a travel path for solving the shortest path problem, while the second constraint condition corresponds to the case where the least-cost path MR is a travel path for solving the traveling salesman problem.

$$Minimize f ( \overline{X} ) = {\sum }_{( i , j ) ∈ P} {c}_{i , j} {x}_{i , j} ( {\overline{x}}^{( k )} ) \qquad [ Equation 1 ]$$

$$\begin{matrix}g ( \overline{X} ) = - {x}_{i , j} ( {\overline{x}}^{( k )} ) \leq 0 & ∀ ( i , j ) ∈ P\end{matrix} \qquad [ Equation 2 ]$$

$$- 1 \leq {\overline{x}}^{( k )} \leq 1 \qquad ∀ k$$

$$\begin{matrix}g ( \overline{X} ) = - {x}_{i , j} ( {\overline{x}}^{( k )} ) \leq 0 & ∀ ( i , j ) ∈ P\end{matrix} \qquad [ Equation 3 ]$$

$${g}_{w} ( \overline{X} ) = b - \sum {x}_{w , adj} ( {\overline{x}}^{( k )} ) \leq 0 \qquad ∀ w$$

$$- 2 \leq {\overline{x}}^{( k )} \leq 2 \qquad ∀ k$$

Equations 1 may be an equation that defines the objective function. Equation 2 may be an equation that defines the first constraint condition. Equation 3 may be an equation that defines the second constraint condition.

In Equations 1 to 3, f(x̅) may represent the objective function i,j may correspond to node i and node j, respectively, among the plurality of nodes. P may correspond to the set of reference link variables. c_{i,j} as may be the link cost corresponding to the link path connecting node i and node j among the plurality of link costs. x_{i,j} may be the link variable corresponding to the link path connecting node i and node j among the plurality of link variables. x̅^{(k)} may be loop variables adjacent to x_{i,j} among the plurality of link variables. b may be the value of a base path variable. w may be a node among the plurality of nodes that corresponds to an intermediate point. x_{w,adj} may be link variables adjacent to the node corresponding to the intermediate point among the plurality of link variables.

In an embodiment of the present disclosure, the computing device SV may be configured to perform the second iteration and select the least-cost path MR using at least one of the constrained optimization algorithm, convex optimization, gradient-based methods, meta-heuristic algorithm, nature-inspired algorithm, interior-point methods, dynamic programming, linear programming, and deep learning.

The constrained optimization algorithm may be a sensitivity-based exact method. The sensitivity-based exact method may include at least one of the simplex algorithm, interior-point method, branch and bound method, and Lagrange multiplier method.

FIG. 5 shows an exemplary flowchart illustrating a least-cost path selection method RSM according to an embodiment of the present disclosure. The least-cost path selection method RSM may include defining a base variable (S10), calculating a reference link variable (S20), and selecting a least-cost path (S30).

In the step of defining a base variable (S10), the computing device SV may define a link cost C, a link variable LK, and a loop variable LP in the node network NN. A loop path may be a closed path connecting at least three nodes among a plurality of nodes ND1-ND16. The loop variable LP may correspond to the loop path and may be a variable having a value and a direction. A link path may be a path connecting any two adjacent nodes among the plurality of nodes ND1-ND16, and the link cost C may be a constant corresponding to the link path. The link variable LK may be a variable whose direction is determined by adjacent loop variables.

In the step of calculating a reference link variable (S20), the computing device SV may modify the plurality of loop variables LP1-LP9 based on at least one of Loop-wise Route Representation (LRR) and a circuit analysis method to calculate a plurality of reference link variables RK1-RK24. The circuit analysis method may include at least one of Mesh Current Method (MCM), Nodal Analysis, and Numerical Method. Each of the reference link variables RK1-RK24 may be a link variable LK having a determined direction.

In the step of selecting a least-cost path (S30), the computing device SV may modify the values of the plurality of loop variables LP1-LP9 within the range where the directions of the plurality of reference link variables RK1-RK24 remain unchanged and may select the least-cost path MR using a linear objective function. The least-cost path MR may be a travel path having the smallest objective function value among a plurality of travel paths. Each of the plurality of travel paths may be a travel path connecting any two nodes among the plurality of nodes ND1-ND16.

In LRR in the step of calculating a reference link variable (S20) according to an embodiment of the present disclosure, the computing device SV may perform a first iteration a predetermined number of times. The first iteration may be an operation to modify at least a portion of the plurality of loop variables LP1-LP9 to calculate the plurality of reference link variables RK1-RK24.

MCM may include defining a plurality of meshes in an electrical circuit CR containing a plurality of resistors R1-R24 and then calculating a plurality of mesh currents I0-I9 corresponding to the plurality of meshes using the plurality of resistors R1-R24.

In MCM in the step of calculating a reference link variable (S20) according to an embodiment of the present disclosure, a plurality link costs C1-C24 may be used instead of the plurality of resistors R1-R24 to calculate the plurality of mesh currents I0-I9. The computing device SV may calculate the first to ninth mesh currents I1-I9 as the plurality of loop variables LP1-LP9, respectively.

In the step of selecting a least-cost path (S30), the computing device SV may generate a plurality of travel paths based on the plurality of reference link variables RK1-RK24 and the plurality of link costs C1-C24. Moreover, the computing device SV may use a linear objective function to calculate a plurality of objective function values associated with the plurality of travel paths. The least-cost path MR may be a travel path having the smallest objective function value among the plurality of objective function values.

In the step of selecting a least-cost path (S30), the computing device SV may select the least-cost path MR based on at least one of Equation 1, Equation 2, and Equation 3.

$$Minimize f ( \overline{X} ) = {\sum }_{( i , j ) ∈ P} {c}_{i , j} {x}_{i , j} ( {\overline{x}}^{( k )} ) \qquad [ Equation 1 ]$$

$$\begin{matrix}g ( \overline{X} ) = - {x}_{i , j} ( {\overline{x}}^{( k )} ) \leq 0 & ∀ ( i , j ) ∈ P\end{matrix} \qquad [ Equation 2 ]$$

$$- 1 \leq {\overline{x}}^{( k )} \leq 1 \qquad ∀ k$$

$$\begin{matrix}g ( \overline{X} ) = - {x}_{i , j} ( {\overline{x}}^{( k )} ) \leq 0 & ∀ ( i , j ) ∈ P\end{matrix} \qquad [ Equation 3 ]$$

$${g}_{w} ( \overline{X} ) = b - \sum {x}_{w , adj} ( {\overline{x}}^{( k )} ) \leq 0 \qquad ∀ w$$

$$- 2 \leq {\overline{x}}^{( k )} \leq 2 \qquad ∀ k$$

Equations 1 may be an equation that defines the objective function. Equation 2 may be an equation that defines a first constraint condition. Equation 3 may be an equation that defines a second constraint condition.

In Equations 1 to 3, f(x̅) may represent the objective function. i,j may correspond to node i and node j, respectively, among the plurality of nodes. P may correspond to the set of reference link variables. c_{i,j} may be the link cost corresponding to the link path connecting node i and node j among the plurality of link costs. x_{i,j} may be the link variable corresponding to the link path connecting node i and node j among the plurality of link variables. x̅^{(k)} may be loop variables adjacent to x_{i,j} among the plurality of link variables. b may be the value of a base path variable. w may be a node among the plurality of nodes that corresponds to an intermediate point. x_{w,adj} may be link variables adjacent to the node corresponding to the intermediate point among the plurality of link variables.

In the step of selecting a least-cost path (S30), the computing device SV may perform a second iteration and select the least-cost path MR using at least one of the constrained optimization algorithm, convex optimization, gradient-based methods, meta-heuristic algorithm, nature-inspired algorithm, interior-point methods, dynamic programming, linear programming, and deep learning, the constrained optimization algorithm may be a sensitivity-based exact method.

Other details are substantially identical to those described with reference to FIGS. 1 to 4B and thus will be omitted.

Although certain embodiments have been described with reference to the accompanying drawings, those skilled in the art to which the present disclosure pertains will understand that various modifications and permutations can be made to the present disclosure without departing from the technical ideas and scope of the present disclosure as set forth in the appended claims. The embodiments disclosed herein are not intended to limit the technical ideas of the present disclosure, and all technical ideas within the scope of the appended claims and their equivalents should be interpreted as falling within the scope of the present disclosure.

What is claimed is:

1. A least-cost path selection system comprising a computing device configured to select a least-cost path having a smallest objective function value among a plurality of travel paths, each of the plurality of travel paths connecting any two nodes among a plurality of nodes,
wherein a link path is defined as a path connecting any two adjacent nodes among the plurality of nodes, and a loop path is defined as a closed path connecting at least three nodes among the plurality of nodes,
wherein a loop variable is a variable corresponding to the loop path and having a value and a direction, a link variable is a variable whose direction is determined by loop variables adjacent to the link path, and a link cost is a constant corresponding to the link path,
wherein the computing device is configured to modify at least one of a plurality of loop variables based on at least one of Loop-wise Route Representation (LRR) and a circuit analysis method to calculate a plurality of reference link variables, each of the plurality of reference link variables being a link variable with a determined direction, the circuit analysis method comprising at least one of Mesh Current Method (MCM), Nodal Analysis, and Numerical Method, and
wherein the computing device is configured to modify the values of the plurality of loop variables within a range where the directions of the plurality of reference link variables remain unchanged and to select the least-cost path using a linear objective function.

2. The least-cost path selection system of claim 1, wherein, in the Loop-wise Route Representation (LRR), the computing device is configured to perform an iteration a predetermined number of times, the iteration being an operation of modifying at least a portion of the plurality of loop variables.

3. The least-cost path selection system of claim 2, wherein the predetermined number of times is greater than or equal to 1 and less than or equal to 10.

4. The least-cost path selection system of claim 1, wherein the Mesh Current Method (MCM) includes defining a plurality of meshes in an electrical circuit comprising a plurality of resistors and then calculating a plurality of mesh currents corresponding to the plurality of meshes using the plurality of resistors, and
wherein, in the MCM, the plurality of link costs are used instead of the plurality of resistors to calculate the plurality of mesh currents, and the computing device is configured to calculate the plurality of mesh currents as the plurality of loop variables, respectively.

5. The least-cost path selection system of claim 1, wherein the computing device is configured to calculate a plurality of objective function values associated with the plurality of travel paths using the objective function, and the least-cost path is a travel path having a smallest objective function value among the plurality of objective function values.

6. The least-cost path selection system of claim 5, wherein, when the least-cost path is a travel path for solving a shortest path problem, the computing device is configured to select the least-cost path based on Equation 1 and Equation 2,
wherein Equation 1 is
$$Minimize f ( \overline{X} ) = {\sum }_{( i , j ) ∈ P} {c}_{i , j} {x}_{i , j} ( {\overline{x}}^{( k )} ) ,$$
wherein Equation 2 is
$$g ( \overline{X} ) = - {x}_{i , j} ( {\overline{x}}^{( k )} ) \leq 0 \qquad ∀ ( i , j ) ∈ P$$
$$\begin{matrix}- 1 \leq {\overline{x}}^{( k )} \leq 1 & ∀ k\end{matrix} ,$$
wherein f(x̅) is the objective function; i,j correspond to node i and node j, respectively, among the plurality of nodes; P corresponds to a set of reference link variables; c_{i,j} is the link cost corresponding to the link path connecting node i and node j among the plurality of link costs; x_{i,j} is the link variable corresponding to the link path connecting node i and node j among the plurality of link variables; x̅^{(k)} and is loop variables adjacent to x_{i,j} among the plurality of link variables.

7. The least-cost path selection system of claim 5, wherein, when the least-cost path is a travel path for solving a traveling salesman problem, the computing device is configured to select the least-cost path based on Equation 1 and Equation 3,
wherein Equation 1 is
$$Minimize f ( \overline{X} ) = {\sum }_{( i , j ) ∈ P} {c}_{i , j} {x}_{i , j} ( {\overline{x}}^{( k )} ) ,$$
wherein Equation 3 is
$$g ( \overline{X} ) = - {x}_{i , j} ( {\overline{x}}^{( k )} ) \leq 0 \qquad ∀ ( i , j ) ∈ P$$
$${g}_{w} ( \overline{X} ) = b - \sum {x}_{w , adj} ( {\overline{x}}^{( k )} ) \leq 0 \qquad ∀ w$$
$$\begin{matrix}- 2 \leq {\overline{x}}^{( k )} \leq 2 & ∀ k\end{matrix} ,$$
wherein f(x̅) is the objective function; i,j correspond to node i and node j, respectively, among the plurality of nodes; P corresponds to a set of reference link variables; c_{i,j} is the link cost corresponding to the link path connecting node i and node j among the plurality of link costs; x_{i,j} is the link variable corresponding to the link path connecting node i and node j among the plurality of link variables; x̅^{(k)} is loop variables adjacent to x_{i,j} among the plurality of link variables; b is a value of a base path variable; w is a node among the plurality of nodes that corresponds to an intermediate point; x_{w,adj} is link variables adjacent to the node corresponding to the intermediate point among the plurality of link variables.

8. The least-cost path selection system of claim 1, wherein the computing device is configured to select the least-cost path using at least one of a constrained optimization algorithm, convex optimization, gradient-based methods, meta-heuristic algorithm, nature-inspired algorithm, interior-point methods, dynamic programming, linear programming, and deep learning.

9. The least-cost path selection system of claim 8, wherein the constrained optimization algorithm is a sensitivity-based exact method.

10. The least-cost path selection system of claim 9, wherein the sensitivity-based exact method comprises at least one of a simplex algorithm, an interior point method, a branch and bound method, and a Lagrange multiplier method.

11. The least-cost path selection system of claim 1, wherein the link cost is at least one of travel distance, travel time, and energy consumption corresponding to the link path.

12. The least-cost path selection system of claim 1, further comprising:
a user terminal configured to communicate with the computing device,
wherein the computing device is configured to provide the least-cost path to the user terminal.

13. The least-cost path selection system of claim 12, wherein the user terminal is integrated into a vehicle.

14. The least-cost path selection system of claim 1, wherein the computing device is configured for at least one of urban environment management and mobility control.

15. A least-cost path selection method comprising:
defining a base variable, wherein a computing device defines a link costs, a link variable, and a loop variable among a plurality of nodes, the loop variable being a variable corresponding to a loop path and having a value and a direction, the loop path being a closed path connecting at least three nodes among the plurality of nodes, the link variable being a variable whose direction is determined by loop variables adjacent to a link path, the link path being a path connecting any two adjacent nodes among the plurality of nodes, and the link cost being a constant corresponding to the link path;
calculating a reference link variable, wherein the computing device modifies at least one of a plurality of loop variables based on at least one of Loop-wise Route Representation (LRR) and a circuit analysis method to calculate a plurality of reference link variables, each of the plurality of reference link variables being a link variable with a determined direction, the circuit analysis method including at least one of Mesh Current Method (MCM), Nodal Analysis, and Numerical Method; and
selecting a least-cost path, wherein the computing device modifies the values of the plurality of loop variables within a range where the directions of the plurality of reference link variables remain unchanged and selects the least-cost path using a linear objective function, the least-cost path being a travel path having a smallest objective function value among a plurality of travel paths, each of the plurality of travel paths connecting any two nodes among the plurality of nodes.

16. The least-cost path selection method of claim 15, wherein, in the step of calculating a reference link variable, in the Loop-wise Route Representation (LRR), the computing device performs an iteration a predetermined number of times, the iteration being an operation of modifying at least a portion of the plurality of loop variables.

17. The least-cost path selection method of claim 15, wherein the Mesh Current Method (MCM) comprises defining a plurality of meshes in an electrical circuit comprising a plurality of resistors and then calculating a plurality of mesh currents corresponding to the plurality of meshes using the plurality of resistors, and
wherein, in the MCM in the step of calculating a reference link variable, the plurality of link costs are used instead of the plurality of resistors to calculate the plurality of mesh currents, and the computing device calculates the plurality of mesh currents, respectively, as the plurality of loop variables.

18. The least-cost path selection method of claim 15, wherein, in the step of selecting a least-cost path, the computing device generates a plurality of travel paths based on the plurality of reference link variables and the plurality of link costs and calculates a plurality of objective function values associated with the plurality of travel paths using the objective function.

19. The least-cost path selection method of claim 15, wherein, in the step of selecting a least-cost path, the computing device selects the least-cost path based on at least one of Equation 1, Equation 2, and Equation 3,
wherein Equation 1 is
$$Minimize f ( \overline{X} ) = {\sum }_{( i , j ) ∈ P} {c}_{i , j} {x}_{i , j} ( {\overline{x}}^{( k )} ) ,$$
wherein Equation 2 is
$$g ( \overline{X} ) = - {x}_{i , j} ( {\overline{x}}^{( k )} ) \leq 0 \qquad ∀ ( i , j ) ∈ P$$
$$\begin{matrix}- 1 \leq {\overline{x}}^{( k )} \leq 1 & ∀ k\end{matrix} ,$$
wherein Equation 3 is
$$g ( \overline{X} ) = - {x}_{i , j} ( {\overline{x}}^{( k )} ) \leq 0 \qquad ∀ ( i , j ) ∈ P$$
$${g}_{w} ( \overline{X} ) = b - \sum {x}_{w , adj} ( {\overline{x}}^{( k )} ) \leq 0 \qquad ∀ w$$
$$\begin{matrix}- 2 \leq {\overline{x}}^{( k )} \leq 2 & ∀ k\end{matrix} ,$$
wherein f(x̅) is the objective function; i,j correspond to node i and node j, respectively, among the plurality of nodes; P corresponds to a set of reference link variables; c_{i,j} is the link cost corresponding to the link path connecting node i and node j among the plurality of link costs; x_{i,j} is the link variable corresponding to the link path connecting node i and node j among the plurality of link variables; x̅^{(k)} is loop variables adjacent to x_{i,j} among the plurality of link variables; b is a value of a base path variable; w is a node among the plurality of nodes that corresponds to an intermediate point; x_{w,adj} is link variables adjacent to the node corresponding to the intermediate point among the plurality of link variables.

20. The least-cost path selection method of claim 15, wherein, in the step of selecting a least-cost path, the computing device selects the least-cost path using at least one of a constrained optimization algorithm, convex optimization, gradient-based methods, meta-heuristic algorithm, nature-inspired algorithm, interior-point methods, dynamic programming, linear programming, and deep learning, and
wherein the constrained optimization algorithm is a sensitivity-based exact method.
